(19) United States
(12) Patent Application Publication
(10) Pub. No.: US 2011/0134140 A1
(43) Pub. Date: Jun. 9, 2011

(54) APPARATUS AND METHOD FOR KEY LAYOUT ARRANGEMENT IN PORTABLE TERMINAL

(75) Inventor: Se-Chun KANG, Suwon-si (KR)

(73) Assignee: SAMSUNG ELECTRONICS CO. LTD., Suwon-si (KR)

(21) Appl. No.: 12/961,835

(22) Filed: Dec. 7, 2010

(30) Foreign Application Priority Data
Dec. 8, 2009 (KR) 10-2009-0120881

(51) Int. Cl. G09G 5/00

(52) U.S. Cl. 345/619

(57) ABSTRACT

An apparatus and method for determining a keyboard layout arrangement in a portable terminal are provided. A method for determining a keyboard layout in a portable terminal includes selecting a keyboard layout according to a user input, determining a keyboard layout having an optimized key area and shape, if the selected keyboard layout is based on a key area, and determining a keyboard layout optimized to a finger touch, if the selected keyboard layout is not based on a key area.

### PRIORITY

This application claims priority under 35 U.S.C. §119(a) to an application filed in the Korean Intellectual Property Office on Dec. 8, 2009 and assigned Serial No. 10-2009-0120881, the contents of which are incorporated herein by reference.

### BACKGROUND OF THE INVENTION

1. Field of the Invention

The present invention relates generally to an apparatus and method for a keyboard layout arrangement in a portable terminal. More particularly, the present invention relates to an apparatus and method for arranging a keyboard layout in a portable terminal in a user-friendly format.

2. Description of the Related Art

Portable devices such as portable terminals commonly provide a User Interface (UI) based on a touchscreen, in order to reduce the inconvenience to users due to a small size necessary for portability.

In general, a user interface of a portable terminal with a touchscreen has a keyboard input function to enable a user to perform a touch input by using a finger or a stylus pen.

That is, the keyboard input function enables the user to input characters into the portable terminal even without the aid of other peripheral devices.

FIG. 1 is a diagram illustrating an exemplary keyboard layout arrangement in a portable terminal according to the related art.

Referring to FIG. 1, a general keyboard layout arrangement in a touchscreen of a portable terminal has same-sized square buttons aligned densely at the same vertical position in each row.

Keyboard layout arrangement according to the related art typically uses a standard English language desktop keyboard arrangement (e.g., a QWERTY arrangement) that requires a large horizontal area. Thus, the width of each button is very small due to the limitation in the horizontal width of the portable device.

Thus, because the size of each key is small in a small screen of the portable terminal, or because it does not match the shape of a touching finger, many typing errors may occur during the input of characters by the user.

### SUMMARY OF THE INVENTION

An aspect of the present invention is to address at least the above-mentioned problems and/or disadvantages and to provide at least the advantages described below. Accordingly, an aspect of the present invention is to provide an apparatus and method for keyboard layout arrangement in a portable terminal.

Another aspect of the present invention is to provide an apparatus and method for reducing typing errors during the keyboard input in a touchscreen without significantly changing the size of a screen, the size of each key and the shape of each key in a portable terminal.

In accordance to an aspect of the present invention, a method for determining a keyboard layout in a portable terminal comprising a touchscreen includes: selecting a desired keyboard layout according to a user input, determining a keyboard layout comprising an optimized key area and shape, if the selected keyboard layout is based on a key area, and determining the keyboard layout optimized to a finger touch, if the selected keyboard layout is not based on a key area.

According to another aspect of the present invention, an apparatus for determining a keyboard layout in a portable terminal includes: a touchscreen configured for receiving a touch input from a user and for performing a screen display, and a keyboard layout unit for selecting a keyboard layout according to a user input, for determining a keyboard layout comprising an optimized key area and shape, if the selected keyboard layout is based on a key area, and for determining a keyboard layout optimized to a finger touch, if the selected keyboard layout is not based on a key area.

According to another aspect of the present invention, a keyboard layout in a touchscreen of a portable terminal includes a keyboard layout in which centers of keys are arranged in each row in a substantially zigzag manner, the zigzag key arrangement is used to increase a central width of each key compared to a keyboard layout comprising keys of constant width, an English language keyboard arrangement of the keyboard layout is based on a QWERTY arrangement, and a Korean language keyboard arrangement of the keyboard layout is base on a 2-way arrangement or a 3-way arrangement.

According to another aspect of the present invention, a keyboard layout in a touchscreen of a portable terminal includes a keyboard layout in which a shape of each key comprises an ellipse or circle to provide a key shape optimized for fingers, an English language keyboard arrangement of the keyboard layout is based on a QWERTY arrangement, and a Korean language keyboard arrangement of the keyboard layout is base on a 2-way arrangement or a 3-way arrangement.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings in which:

FIG. 1 is a diagram illustrating an exemplary keyboard layout arrangement in a portable terminal according to the related art;

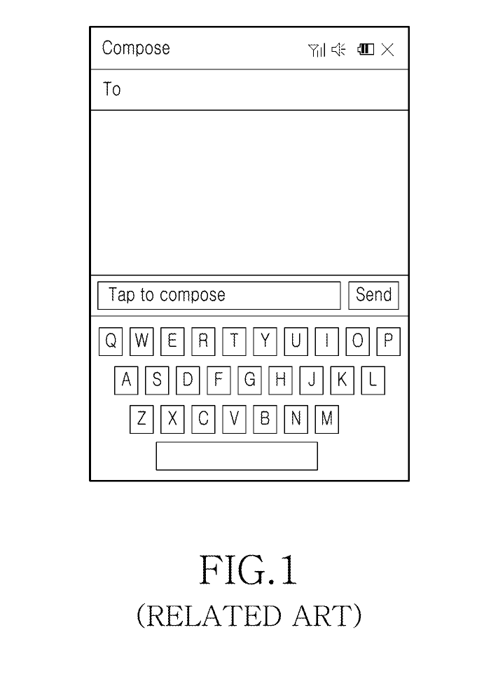

FIG. 2 is a diagram illustrating a keyboard layout according to an exemplary embodiment of the present invention;

FIG. 3 is a diagram illustrating a keyboard layout according to an exemplary embodiment of the present invention;

FIG. 4 is a flow diagram illustrating a process for changing a keyboard layout according to an exemplary embodiment of the present invention;

FIG. 5 is a flow diagram illustrating a process for changing a keyboard layout according to an exemplary embodiment of the present invention; and

FIG. 6 is a block diagram of a portable terminal according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention include an apparatus and method for keyboard layout arrangement in a portable terminal.

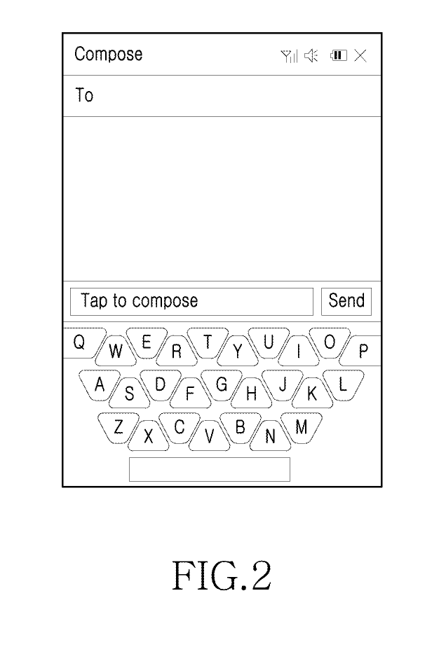

FIG. 2 is a diagram illustrating a keyboard layout according to an exemplary embodiment of the present invention.

Referring to FIG. 2, keys are arranged in each row in a zigzag manner, and the area increased by the zigzag arrangement is used to increase the size of each key without increasing the width required for the entire row. The zigzag key arrangement increases the area and the horizontal width of each key. Because the shape of a touch surface of a finger with a touchscreen is circular or elliptical, the finger can reliably contact each key.

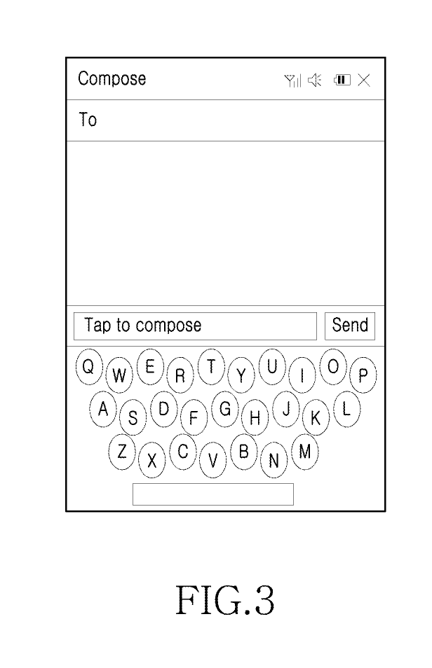

FIG. 3 is a diagram illustrating a keyboard layout according to an exemplary embodiment of the present invention.

FIG. 3 illustrates the case where the shape of each key is circular, to which the present invention is not limited. Each key may have various shapes such as trapezoid, triangle, circle, and ellipse, for example.

That is, the change of the key shape from square to ellipse or circle makes it possible to select the key shape optimized to a finger touch and to an available area of the input device, and to increase the key input success rate of the user.

The above keyboard layout may be implemented by software. Thus, a function for changing the keyboard layout may be implemented by software.

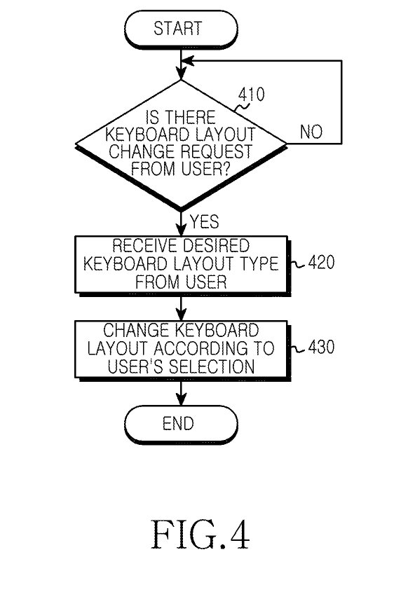

FIG. 4 is a flow diagram illustrating a process for changing a keyboard layout according to an exemplary embodiment of the present invention.

Referring to FIG. 4, when the portable terminal receives a keyboard layout change request from the user in step 410, the portable terminal receives a desired keyboard layout from the user in step 420.

In this case, the portable terminal displays selectable keyboard layout types to the user, and the user selects one of the keyboard layout types.

In step 430, the portable terminal changes the keyboard layout according to the user's selection.

Thereafter, the portable terminal ends the algorithm according to the exemplary embodiment of the present invention.

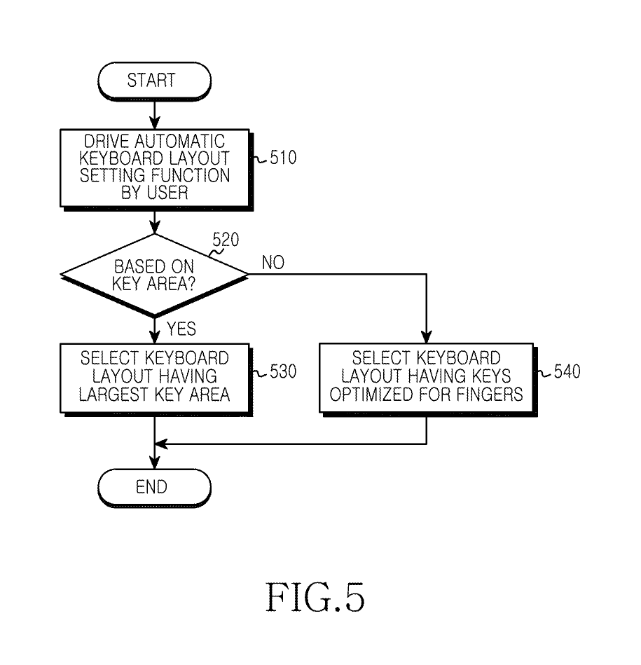

FIG. 5 is a flow diagram illustrating a process for changing a keyboard layout according to an exemplary embodiment of the present invention.

FIG. 5 illustrates the case where the user presets a desired keyboard layout type and the portable terminal changes the keyboard layout according to the value set by the user in a driving program.

Referring to FIG. 5, an automatic keyboard layout setting function is driven by the user in step 510. If the value preset by the user is based on a key area in step 520, the keyboard layout is determined such that each key have the largest area in step 530. This corresponds to the case of FIG. 2.

If the value preset by the user is not based on a key area in step 520, the keyboard layout to be used is determined as the keyboard layout having keys optimized for a shape of a finger touch in step 540. This corresponds to the case of FIG. 3.

Thereafter, the portable terminal ends the algorithm according to the exemplary embodiment of the present invention.

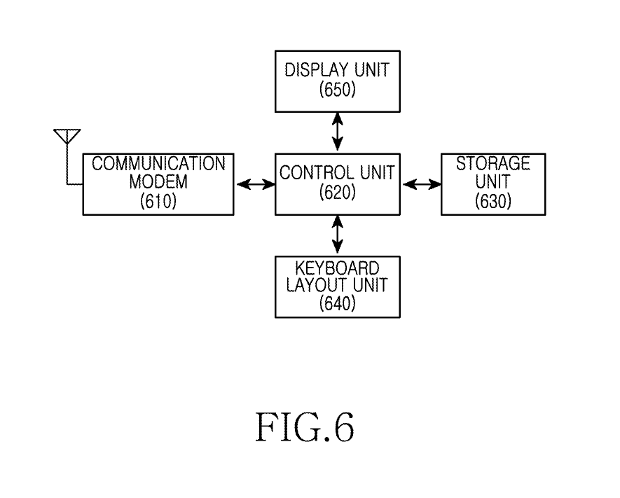

FIG. 6 is a block diagram of a portable terminal according to an exemplary embodiment of the present invention.

Referring to FIG. 6, the portable terminal includes a communication modem 610, a control unit 620, a storage unit 630, a keyboard layout unit 640, and a display unit 650.

The communication modem 610 includes a Radio Frequency (RF) processing unit and a baseband processing unit. The RF processing unit changes an RF signal, received through an antenna, into a baseband signal and provides the same to the baseband processing unit. Also, the RF processing unit changes a baseband signal, received from the baseband processing unit, into an RF signal to be transmitted through the antenna.

The control unit 620 controls an overall operation of the portable terminal. For example, the control unit 620 processes and controls voice communication and data communication. In addition to the general functions, according to exemplary embodiments of the present invention, the control unit 620 controls the keyboard layout unit 640.

The storage unit 630 stores a program for controlling an overall operation of the portable terminal, and temporary data that are generated during the execution of various programs. In particular, according to exemplary embodiments of the present invention, the storage unit 630 stores keyboard layout arrangements.

The display unit 650 displays data outputted from the control unit 620. Although not illustrated in FIG. 6, the display unit 650 has a touch function, and inputted touch data are provided to the control unit 620. That is, the display unit 650 performs a touchscreen function.

The keyboard layout unit 640 receives a desired keyboard layout from the user when receiving a keyboard layout change request from the user. In this case, the portable terminal displays selectable keyboard layout types to the user, and the user selects one of the keyboard layout types. The keyboard layout unit changes the keyboard layout according to the user's selection. This corresponds to the case where the user presets a desired keyboard layout type and the portable terminal changes the keyboard layout according to the value set by the user in a driving program.

When an automatic keyboard layout setting function is driven by the user, if the value preset by the user is based on a key area, the keyboard layout unit 640 determines the keyboard layout such that each key has the largest available area. This corresponds to the case of FIG. 2. If the value preset by the user is not based on a key area, the keyboard layout to be used is determined as the keyboard layout having keys optimized for the shape of a finger touch. This corresponds to the case of FIG. 3.

In the determined keyboard layout, for example, an English language arrangement uses a QWERTY arrangement, and a Korean language arrangement may use a 2-way arrangement or a 3-way arrangement. Other languages, of course, would use arrangements according to standard keyboard layouts of the other languages.

In the above block configuration, the control unit 620 may also be configured to perform the functions of the keyboard layout unit 640.

Although separate units are provided for respective functions of the control unit 620, the control unit 620 may also be configured to perform all or some of the functions on behalf of such separate units.

As described above, exemplary embodiments of the present invention optimize the keyboard input key shape and area to the contact area of a finger in a touchscreen, thereby making it possible to increase the key input success rate.

While the invention has been shown and described with reference to certain preferred embodiments thereof, it will be understood by those skilled in the art that various changes in form and details may be made therein without departing from the spirit and scope of the invention as defined by the appended claims and their equivalents. Therefore, the scope of the invention is defined not by the detailed description of the invention but by the appended claims, and all differences within the scope will be construed as being included in the present invention.

What is claimed is:

1. A method for determining a keyboard layout in a portable terminal comprising a touchscreen, the method comprising:
selecting, by a keyboard layout unit, a keyboard layout according to a user input;
determining, by the keyboard layout unit, a keyboard layout comprising an optimized key area and shape, if the selected keyboard layout is based on a key area; and
determining, by the keyboard layout unit, a keyboard layout optimized to a finger touch, if the selected keyboard layout is not based on a key area.

2. The method of claim 1, wherein the determining of the keyboard layout comprising the optimized key area and shape comprises:
arranging keys in each row such that centers of the keys are arranged in a substantially zigzag manner; and
determining a keyboard layout comprising an increased key central width, due to the zigzag key arrangement, compared to a keyboard layout comprising keys of constant width.

3. The method of claim 2, wherein a shape of each key comprises a substantially trapezoidal or triangular shape.

4. The method of claim 2, wherein a shape of each key comprises a substantially circular or elliptical shape.

5. The method of claim 1, wherein the determining of the keyboard layout optimized to the finger touch comprises:
changing a key shape into an ellipse or circle; and
determining a keyboard layout comprising a key shape optimized for the finger touch.

6. The method of claim 5,
wherein the key shape comprises an ellipse, and
at least one of a size, location, and orientation of each elliptical key are optimized.

7. The method of claim 1, wherein the keyboard layout is determined according to a language selected by the user.

8. The method of claim 7, wherein an English language keyboard arrangement of the keyboard layout is based on a QWERTY arrangement.

9. The method of claim 7, wherein a Korean language keyboard arrangement of the keyboard layout is based on a 2-way arrangement or a 3-way arrangement.

10. An apparatus for determining a keyboard layout in a portable terminal, the apparatus comprising:
a touchscreen for receiving a touch input from a user and for performing a screen display; and
a keyboard layout unit for selecting a keyboard layout according to a user input, for determining a keyboard layout comprising an optimized key area and shape, if the selected keyboard layout is based on a key area, and for determining a keyboard layout optimized to a finger touch, if the selected keyboard layout is not based on a key area.

11. The apparatus of claim 10, wherein the keyboard layout unit arranges keys in each row such that centers of each key in the row are arranged in a substantially zigzag manner, and determines a keyboard layout comprising an increased key central width, due to the zigzag key arrangement, compared to a keyboard layout comprising keys of constant width.

12. The apparatus of claim 11, wherein a shape of each key comprises a substantially trapezoidal or triangular shape.

13. The apparatus of claim 11, wherein a shape of each key comprises a substantially circular or elliptical shape.

14. The apparatus of claim 10, wherein the keyboard layout unit changes the key shape into an ellipse or circle, and determines the keyboard layout having a key shape optimized for the finger touch.

15. The apparatus of claim 14,
wherein the key shape comprises an ellipse, and
at least one of a size, location, and orientation of each elliptical key are optimized.

16. The apparatus of claim 10, wherein the keyboard layout is determined according to a language selected by the user.

17. The apparatus of claim 16, wherein an English language keyboard arrangement of the keyboard layout is based on a QWERTY arrangement.

18. The apparatus of claim 16, wherein a Korean language keyboard arrangement of the keyboard layout is base on a 2-way arrangement or a 3-way arrangement.

19. A keyboard layout in a touchscreen of a portable terminal, comprising:
a keyboard layout in which centers of keys are arranged in each row in a substantially zigzag manner, the zigzag key arrangement is used to increase a central width of each key compared to a keyboard layout comprising keys of constant width, an English language keyboard arrangement of the keyboard layout is based on a QWERTY arrangement, and a Korean language keyboard arrangement of the keyboard layout is base on a 2-way arrangement or a 3-way arrangement.

20. A keyboard layout in a touchscreen of a portable terminal, comprising:
a keyboard layout in which a shape of each key comprises an ellipse or circle to provide a key shape optimized for fingers, an English language keyboard arrangement of the keyboard layout is based on a QWERTY arrangement, and a Korean language keyboard arrangement of the keyboard layout is base on a 2-way arrangement or a 3-way arrangement.
